(19) United States
(12) Patent Application Publication
(10) Pub. No.: US 2026/0344947 A1
(43) Pub. Date: Nov. 5, 2026

(54) PORE CLEANSING AND MASSAGE DEVICE

(71) Applicant: YORK AIRCONDITIONING CORPORATION, Seoul (KR)

(72) Inventors: Kiho HONG, Seoul (KR); Wonbae HONG, Seoul (KR); Yeeun HONG, Seoul (KR); Sungeun HONG, Seoul (KR)

(73) Assignee: YORK AIRCONDITIONING CORPORATION, Seoul (KR)

(21) Appl. No.: 19/120,785

(22) PCT Filed: Oct. 6, 2023
(86) PCT No.: PCT/KR2023/015403

§ 371 Date: Apr. 13, 2025

(30) Foreign Application Priority Data
Oct. 13, 2022 (KR) 10-2022-0131603

(51) Int. Cl. A47K 7/04; A61H 23/04

(52) U.S. Cl. CPC A47K 7/04; A61H 23/04

(57) ABSTRACT

The present invention relates to a pore cleansing and massage device including: a chamber unit for accommodating cleansing water introduced from the outside through the inner space thereof; and a nozzle unit coupled to the chamber unit so as to spray the cleansing water accommodated in the chamber unit in the form of a plurality of fine streams through a plurality of fine holes communicating with the inner space of the chamber unit, wherein the fine holes are formed at a plurality of points on a disc member insert-molded onto a support surface supporting a plurality of protrusions having passageways longitudinally extending from the nozzle unit, and communicate with the passageways, so that the cleansing water having passed through the fine holes is sprayed in the form of a fine stream through the passageway of each of the protrusions.

### TECHNICAL FIELD

The present disclosure relates to a pore cleansing and massage device, and more particularly, to a pore cleansing and massage device that directly sprays fine streams of washing water to pores through a nozzle part, making it easy to wash away contaminants stuck in skin pores and around the pores by the fine streams of washing water, thereby allowing the skin to be kept cleaner.

### BACKGROUND ART

During daily life, various contaminants such as dust can stick to the body, especially the skin.

Therefore, skin cleanliness is maintained by showering and shampooing to wash away contaminants stuck to the skin.

However, there is a problem that contaminants stuck to the skin's fine parts, such as in pores and around the pores, are not easy to wash away with just showering and shampooing.

That is, a water stream sprayed through a general “showerhead” disclosed in Korean Patent Publication No. 10-2022-0084643 has a considerable droplet size, which means that it does not easily reach the skin's fine parts such as pores, and thus there is a problem that it is difficult to wash away contaminants remaining on the corresponding parts.

At this time, contaminants remaining on the skin's fine parts such as pores not only impede cleanliness of the skin but also cause skin diseases in particular.

For this reason, showerheads have been proposed that have outlets of a finer diameter to spray a thinner stream of washing water compared to a general showerhead.

However, when the diameter of the outlets is made finer in the showerheads, there is a problem that the spray of washing water does not meet expectations.

That is, when the diameter of the outlets is made finer in the showerheads, there is a problem that the sprayed amount and spray pressure of the washing water do not meet expectations, and in particular, when front ends of the outlets come into contact with the skin or hair, hair clumps together and acts as a barrier, and there is a problem that even if the washing water is sprayed, it does not reach the pores directly, and the cleansing power is weak.

For the above reasons, in the relevant field, there have been attempts to develop a device that makes it easy to wash away contaminants stuck in pores and around the pores by spraying fine streams of washing water, but satisfactory results have not been obtained to date.

### DISCLOSURE

### Technical Problem

The present disclosure has been proposed to address the problems of the related art and is directed to providing a pore cleansing and massage device that directly sprays fine streams of washing water to pores through a nozzle part, making it easy to wash away contaminants stuck in pores and around the pores by the fine streams of washing water.

### Technical Solution

In order to achieve the above objective, the present disclosure proposes a pore cleansing and massage device including: a chamber part accommodating washing water introduced from the outside through an inner space thereof; and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are formed at a plurality of points on a disc member insert-molded onto a support surface supporting a plurality of protrusions having passages extending in a longitudinal direction formed therein and communicate with the passages, and the washing water that has passed through the fine holes is sprayed in the form of a fine stream through the passage of each of the protrusions.

In order to achieve the above objective,
the present disclosure also proposes a pore cleansing and massage device including: a chamber part accommodating washing water introduced from the outside through an inner space thereof, and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are formed at a plurality of points on a disc member disposed in close contact with an inner side of a support surface supporting a plurality of protrusions having passages extending in a longitudinal direction formed therein and communicate with the passages, and the washing water that has passed through the fine holes is sprayed in the form of a fine stream through the passage of each of the protrusions.

In order to achieve the above objective,
the present disclosure also proposes a pore cleansing and massage device including: a chamber part accommodating washing water introduced from the outside through an inner space thereof; and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are formed at a plurality of points on a support surface supporting a plurality of protrusions having passages extending in a longitudinal direction formed therein and communicate with the passages, and the washing water that has passed through the fine holes is sprayed in the form of a fine stream through the passage of each of the protrusions.

In order to achieve the above objective,
the present disclosure also proposes a pore cleansing and massage device including: a chamber part accommodating washing water introduced from the outside through an inner space thereof, and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are formed at a plurality of points on a support surface supporting a plurality of protrusions and face the protrusions, the fine holes are radially formed at each of the plurality of points, and the washing water that has passed through the fine holes is sprayed in the form of a fine stream between any one and another of a plurality of wings radially disposed on the protrusions.

In order to achieve the above objective,
the present disclosure also proposes a pore cleansing and massage device including: a chamber part accommodating washing water introduced from the outside through an inner space thereof; and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are radially formed on front ends of passages each formed to extend in a longitudinal direction on an inner side of one of a plurality of protrusions supported by a support surface, and the washing water that has passed through the fine holes is sprayed in the form of a fine stream between any one and another of a plurality of wings radially disposed on the protrusions.

In order to achieve the above objective,
the present disclosure also proposes a pore cleansing and massage device including: a chamber part accommodating washing water introduced from the outside through an inner space thereof, and a nozzle part coupled to the chamber part and spraying the washing water accommodated in the chamber part in the form of a plurality of fine streams through a plurality of fine holes communicating with the inner space of the chamber part, wherein, in the nozzle part, the fine holes are radially formed along circumferences of front end portions of passages each formed to extend in a longitudinal direction on an inner side of one of a plurality of conical protrusions supported by a support surface, and the washing water that has passed through the fine holes is sprayed in the form of a fine stream at the circumference of the front end portion of each of the passages.

### Advantageous Effects

In a pore cleansing and massage device according to the present disclosure, since a nozzle part includes fine holes, washing water flowing from a chamber part to the nozzle part can be sprayed in the form of fine streams by passing through the fine holes, the fine streams of washing water affect pores and parts around the pores of a user's skin and make it easy to wash away contaminants stuck in the pores and around the pores, thereby allowing the skin to be kept cleaner.

In addition, in a pore cleansing and massage device according to the present disclosure, since a plurality of protrusions are provided on a nozzle part, not only can massage be performed by a front end of each protrusion coming into contact with the skin, but also blockage of fine holes due to hair is prevented by the protrusions blocking the hair's approach toward the fine holes and a fine stream form of washing water can be maintained intact, thereby making it easy to continuously spray the washing water in the form of fine streams through the fine holes.

In addition, in a pore cleansing and massage device according to the present disclosure, since an inclined surface can be provided on a front end of a protrusion of a nozzle part, a passage inside the protrusion can be widely opened by the inclined surface, and vacuum formation inside the passage can be prevented in a washing water spraying process, thereby making it easy for the washing water to be sprayed in the form of fine streams through fine holes without different streams of the washing water colliding with each other.

In addition, in a pore cleansing and massage device according to the present disclosure, since a slit can be formed at one side of a protrusion of a nozzle part, opening of the protrusion can be performed even by the slit together with a passage, and vacuum formation inside the passage can be prevented in a washing water spraying process, thereby making it easy for the washing water to be sprayed in the form of fine streams through fine holes without different streams of the washing water colliding with each other.

In addition, in a pore cleansing and massage device according to the present disclosure, since a protrusion of a nozzle part can include a moving member that moves forward and reward, as forward and rearward movement of the moving member occurs, stable contact with curved parts of the skin is possible, movement to the curved parts of the skin can be made easy by adjusting a frictional force when in contact with the skin, and thus hair can be parted easily by movement on the skin, washing water can be directly sprayed to pores while avoiding the hair, and massage can be easily performed even when the skin is curved.

In addition, in a pore cleansing and massage device according to the present disclosure, since a moving member of a nozzle part can include a conductor tip that emits a microcurrent as power is applied thereto, electrical stimulation can be applied to the skin as the microcurrent is emitted through the tip in a process of skin massage by contact with protrusions, and a skin massage effect due to the contact with the protrusions can be further enhanced.

In addition, a pore cleansing and massage device according to the present disclosure has an outstanding effect in washing away contaminants on any item in any industry that has high surface roughness and is washed by directly spraying water. That is, contaminants on filters, fruits, vegetables, device surfaces, inner portions of devices, and the like can be easily washed away, and thus an industrial utilization effect is also enhanced.

### DESCRIPTION OF DRAWINGS

FIG. 1 is a perspective view showing an exterior of a pore cleansing and massage device according to the present disclosure.

FIG. 2 is a front view of the pore cleansing and massage device according to the present disclosure.

FIG. 3 is an exemplary view showing washing away contaminants from pores and around the pores through spraying fine streams of washing water using the pore cleansing and massage device according to the present disclosure.

FIG. 4 is an exemplary view for describing spraying of washing water through a nozzle part having one form in the pore cleansing and massage device according to the present disclosure.

FIG. 5 is an exemplary view for describing spraying of washing water through a nozzle part having another form in the pore cleansing and massage device according to the present disclosure.

FIG. 6 is an exemplary view showing a form in which a protrusion further includes a slit in the pore cleansing and massage device according to the present disclosure that is illustrated in FIG. 5.

FIG. 7 is an exemplary view for describing spraying of washing water through a nozzle part having another form in the pore cleansing and massage device according to the present disclosure.

FIG. 8 is an exemplary view in which fine holes are further formed on a support surface of the nozzle part in the pore cleansing and massage device according to the present disclosure that is illustrated in FIG. 7.

FIG. 9 is an exemplary view for describing spraying of washing water through a nozzle part having another form in the pore cleansing and massage device according to the present disclosure.

FIG. 10 is an exemplary view showing one arrangement form of wings of a protrusion in the pore cleansing and massage device according to the present disclosure that is illustrated in FIG. 9.

FIG. 11 is an exemplary view showing another arrangement form of wings of a protrusion in the pore cleansing and massage device according to the present disclosure that is illustrated in FIG. 9.

FIG. 12 is an exemplary view for describing spraying of washing water through a nozzle part having another form in the pore cleansing and massage device according to the present disclosure.

FIG. 13 is an exemplary view showing a form in which a protrusion of a nozzle part is fitted and coupled in the pore cleansing and massage device according to the present disclosure that is illustrated in FIG. 12.

FIG. 14 is an exemplary view showing a form in which a protrusion of a nozzle part includes a moving member having one form in the pore cleansing and massage device according to the present disclosure that is illustrated in FIG. 12.

FIG. 15 is an exemplary view showing a form in which a protrusion of a nozzle part includes a moving member having another form in the pore cleansing and massage device according to the present disclosure that is illustrated in FIG. 12.

FIG. 16 is an exemplary view for describing spraying of washing water through a nozzle part having another form in the pore cleansing and massage device according to the present disclosure.

### MODES OF THE INVENTION

Hereinafter, the present disclosure will be described in detail with reference to the accompanying drawings.

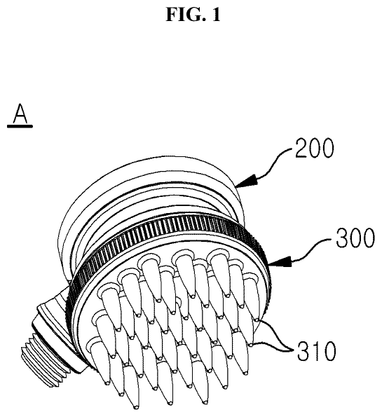

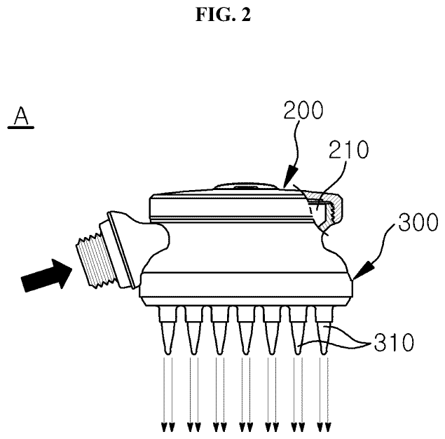

As illustrated in FIGS. 1 and 2, a pore cleansing and massage device A according to the present disclosure includes a chamber part 200 and a nozzle part 300.

The chamber part 200 of the present disclosure accommodates washing water introduced from the outside through an inner space 210.

At this time, the chamber part 200 may have a concave surface (not denoted by a reference numeral) formed along a circumference of an outer circumferential surface and may be easily gripped due to the concave surface.

Meanwhile, the chamber part 200 may have one end connected to a washing water supply tube (not illustrated in the drawings), and washing water supplied through the washing water supply tube may be accommodated in the inner space 210.

Here, for example, the washing water supply tube may be connected to a faucet (not illustrated in the drawings), and supply of washing water may be stably performed.

The nozzle part 300 of the present disclosure is coupled to the chamber part 200 and sprays, more specifically, directly sprays, the washing water accommodated in the chamber part 200 in the form of a plurality of fine streams through a plurality of fine holes H communicating with the inner space 210 of the chamber part 200.

At this time, the nozzle part 300 and the chamber part 200 may be connected using any general method and may be connected using a helical engagement method, for example.

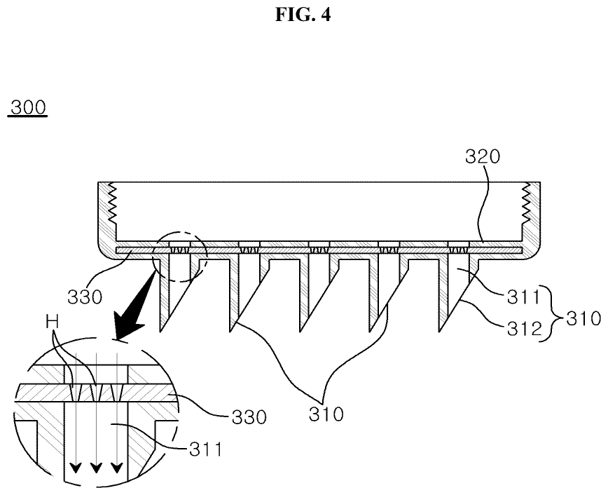

As illustrated in FIG. 4, in the nozzle part 300, the fine holes H may be formed at a plurality of points on a disc member 330 insert-molded onto a support surface 320 supporting a plurality of protrusions 310 having passages 311 extending in a longitudinal direction formed therein and may communicate with the passages 311.

Therefore, the washing water that has passed through the fine holes H may be sprayed in the form of a fine stream through the passage 311 of each of the protrusions 310.

When the fine holes H are formed at the plurality of points on the disc member 330 insert-molded onto the support surface 320, the protrusion 310 of the nozzle part 300 includes an inclined surface 312 formed at a predetermined angle on one end located at a far distance from the support surface 320, and thus, due to the inclined surface 312, the passage 311 may be widely open at a front end of the protrusion 310.

Meanwhile, the fine holes H may have a diameter ranging from 0.05 to 0.2 mm, and in this way, washing water may be sprayed in the form of fine streams.

In addition, the fine holes H may be arranged in groups at each point.

Therefore, washing water may be sprayed in the form of a plurality of fine streams at each point.

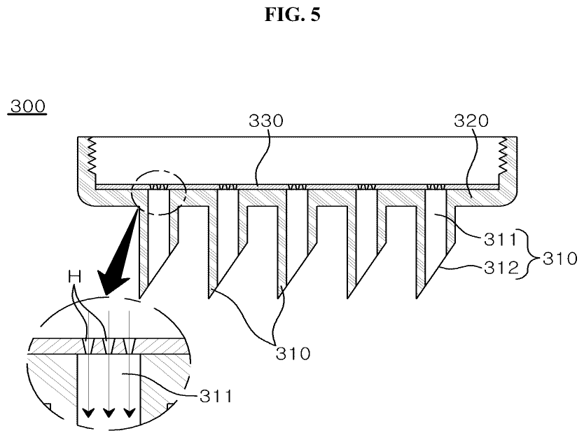

Also, as illustrated in FIG. 5, in the nozzle part 300, the fine holes H may be formed at a plurality of points on a disc member 330 disposed in close contact with an inner side of a support surface 320 supporting a plurality of protrusions 310 having passages 311 extending in a longitudinal direction formed therein and may communicate with the passages 311.

Therefore, the washing water that has passed through the fine holes H may be sprayed in the form of a fine stream through the passage 311 of each of the protrusions 310.

When the fine holes H are formed at the plurality of points on the disc member 330 disposed in close contact with the inner side of the support surface 320, the protrusion 310 of the nozzle part 300 includes an inclined surface 312 formed at a predetermined angle on one end located at a far distance from the support surface 320, and thus, due to the inclined surface 312, the passage 311 may be widely open at a front end of the protrusion 310.

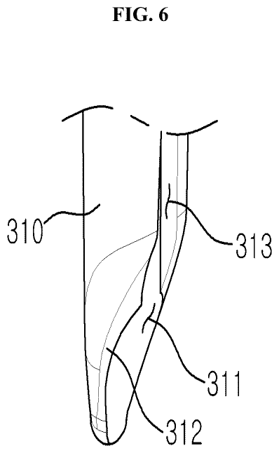

In addition, when the fine holes H are formed at the plurality of points on the disc member 330 disposed in close contact with the inner side of the support surface 320, as illustrated in FIG. 6, the protrusion 310 of the nozzle part 300 further includes a slit 313 formed to extend in a longitudinal direction from one end of the inclined surface 312 that is adjacent to the support surface 320, and thus the protrusion 310 may also be open due to the slit 313.

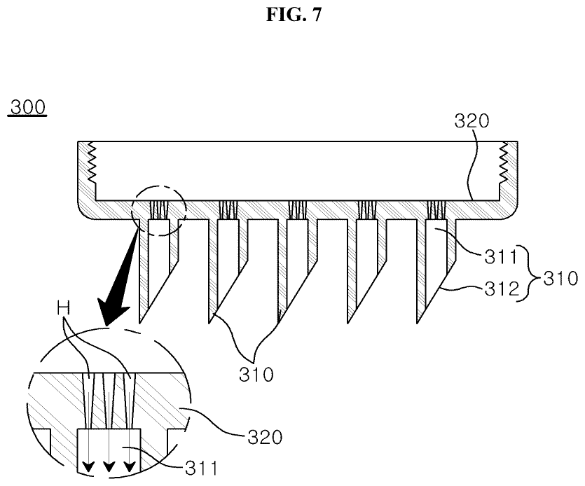

Also, as illustrated in FIG. 7, in the nozzle part 300, the fine holes H may be formed at a plurality of points on a support surface 320 supporting a plurality of protrusions 310 having passages 311 extending in a longitudinal direction formed therein and may communicate with the passages 311.

Therefore, the washing water that has passed through the fine holes H may be sprayed in the form of a fine stream through the passage 311 of each of the protrusions 310.

When the fine holes H are formed at the plurality of points on the support surface 320, the protrusion 310 of the nozzle part 300 includes an inclined surface 312 formed at a predetermined angle on one end located at a far distance from the support surface 320, and thus, due to the inclined surface 312, the passage 311 may be widely open at a front end of the protrusion 310.

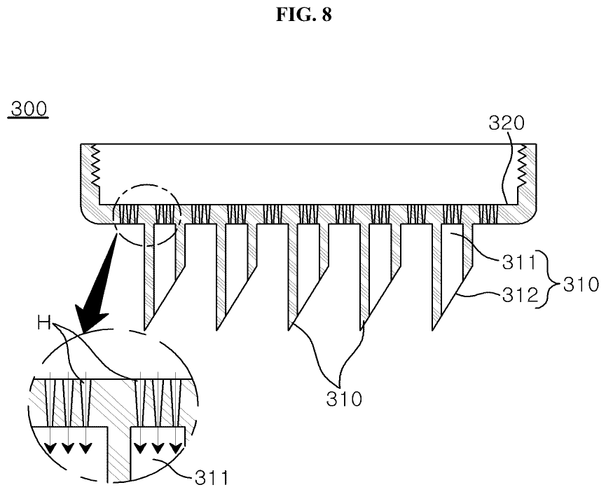

In addition, when the fine holes H are formed at the plurality of points on the support surface 320, as illustrated in FIG. 8, the fine holes H may be further formed at a plurality of points on the support surface 320 outside the passage 311, and thus washing water can also be sprayed in the form of fine streams through the fine holes H outside the passage 311.

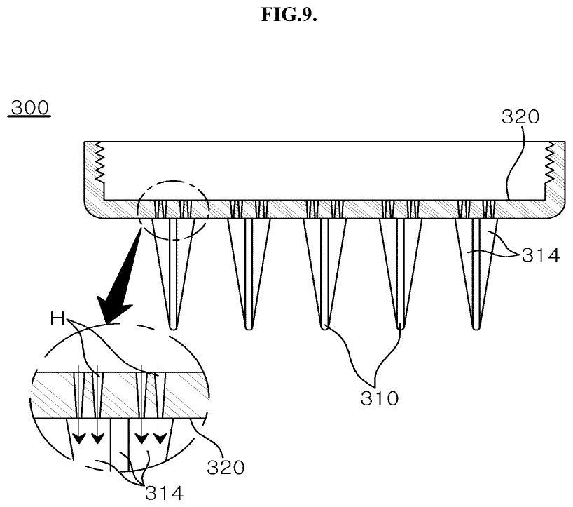

Also, as illustrated in FIGS. 9 to 11, in the nozzle part 300, the fine holes H may be formed at a plurality of points on a support surface 320 supporting a plurality of protrusions 310 and may face the protrusions 310, and the fine holes H may be radially formed at each of the plurality of points.

Therefore, the washing water that has passed through the fine holes H may be sprayed in the form of a fine stream between any one and another of a plurality of wings 314 radially disposed on each protrusion 310.

When the fine holes H are radially formed at each of the plurality of points on the support surface 320, the wings 314 of the protrusion 310 may be formed with a width that gradually narrows toward a front end, and in this way, since the front end of the protrusion 310 including the wings 314 can become sharp, the front end of the protrusion 310 may easily pass between hair strands, hair parting (guiding the hair to portions between the protrusions) may be easily performed, and massage by contact with skin 10 may be facilitated.

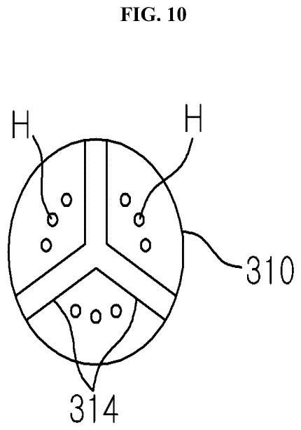

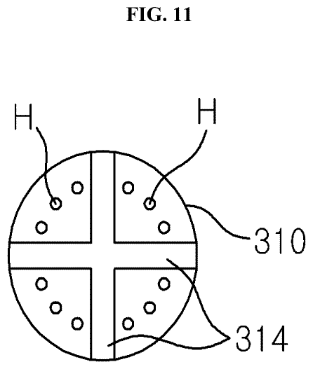

In addition, when the fine holes H are radially formed at each of the plurality of points on the support surface 320, the number of wings 314 of the protrusion 310 is not limited, and for example, the number may be three as illustrated in FIG. 10 or four as illustrated in FIG. 11.

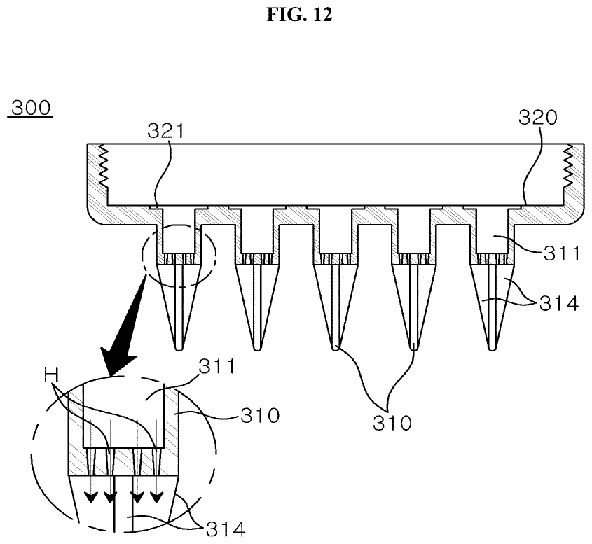

Also, as illustrated in FIG. 12, in the nozzle part 300, the fine holes H may be radially formed on front ends of passages 311 each formed to extend in a longitudinal direction on an inner side of one of a plurality of protrusions 310 supported by a support surface 320.

Therefore, the washing water that has passed through the fine holes H may be sprayed in the form of a fine stream between any one and another of a plurality of wings 314 radially disposed on the protrusions 310.

When the fine holes H are radially formed on the front ends of the passages 311 of the protrusions 310, the wings 314 of the protrusion 310 may be formed with a width that gradually narrows toward the front end, and in this way, since the front end of the protrusion 310 including the wings 314 can become sharp, the front end of the protrusion 310 may easily pass between hair strands, hair parting may be easily performed, and massaging the skin 10 by coming into contact therewith may be facilitated.

In addition, when the fine holes H are radially formed on the front ends of the passages 311 of the protrusions 310, the number of wings 314 of the protrusion 310 is not limited, and for example, the number may be three or four.

In addition, when the fine holes H are radially formed on the front ends of the passages 311 of the protrusions 310, the support surface 320 may include a helical groove 321 formed along a circumference of the passage 311, and in this way, as the washing water of the chamber part 200 swirls and flows over the helical groove 321, introduction of the washing water into the passage 311 may be facilitated.

In addition, when the fine holes H are radially formed on the front ends of the passages 311 of the protrusions 310, central axes of the fine holes H may be parallel to a central axis of the protrusion 310 or may be misaligned with the central axis of the protrusion 310 and tilted 10 to 20° outward so that the washing water gradually heads outward toward the front.

By the central axes of the fine holes H being misaligned with the central axis of the protrusion 310 and tilted outward, the washing water sprayed in the form of fine streams through the fine holes H may affect a larger area of a surface of the skin 10.

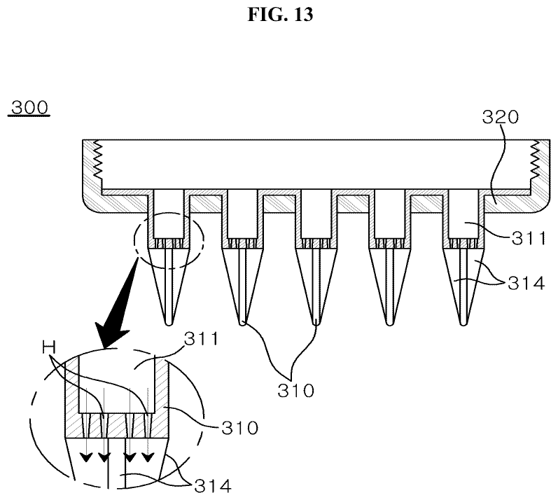

Also, when the fine holes H are radially formed on the front ends of the passages 311 of the protrusions 310, as illustrated in FIG. 13, the plurality of protrusions 310 may be separately manufactured using a flexible material such as rubber or silicone and may be fitted and coupled to the support surface 320, and in this way, during massage of the skin 10 by the protrusions 310 coming into contact therewith, overstimulation can be suppressed due to characteristics of the material of the protrusions 310.

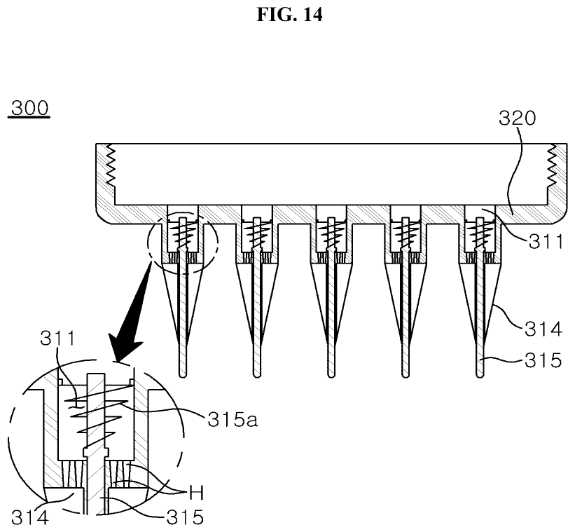

Also, when the fine holes H are radially formed on the front ends of the passages 311 of the protrusions 310, as illustrated in FIG. 14, the protrusions 310 may each include a moving member 315 passing through a center of arrangement of the wings 314 and coupled to be movable forward and rearward, and as forward and rearward movement of the moving member 315 occurs, stable contact with curved parts of the skin is possible, movement to the curved parts of the skin can be made easy by adjusting a frictional force when in contact with the skin, and thus hair can be parted easily by movement on the skin, washing water can be directly sprayed to pores while avoiding the hair, and massage can be easily performed even when the skin is curved.

At this time, a tip of the moving member 315 in a longitudinal direction that extends to an inner side of the passage 311 of the protrusion 310 is elastically supported by an elastic body 315a such as a coil spring, and thus, when pressure release occurs in an insertion state due to pressing, as a stretching force of the elastic body 315a acts, the moving member 315 may automatically return to a before-insertion state, that is, a protruding state.

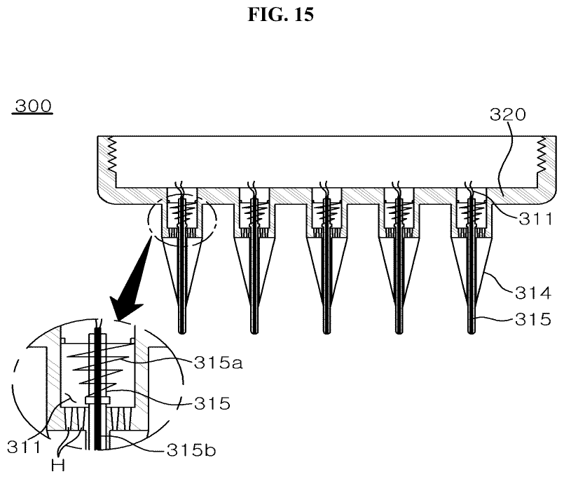

Also, as illustrated in FIG. 15, the moving member 315 may include a conductor tip 315b that emits a microcurrent as power is applied thereto, and thus, by the tip 315b coming into contact with the skin 10 and emitting the microcurrent, a massage effect can be enhanced.

Here, since the tip 315b may have any general structure and use any general method as long as the tip 315b can emit a microcurrent as power is applied thereto, detailed description of the tip 315b will be omitted.

Meanwhile, supply of power to the tip 315b may be performed through a battery (not illustrated in the drawings) mounted on an outer surface of the chamber part 200.

At this time, a wiring (not denoted by a reference numeral) is connected between the tip 315b and the battery.

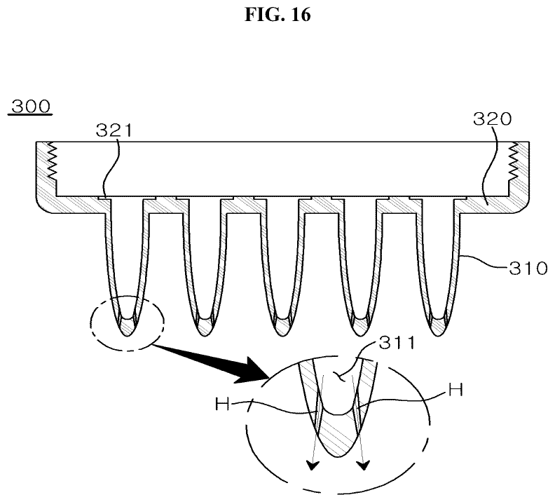

Also, as illustrated in FIG. 16, in the nozzle part 300, the fine holes H may be radially formed along circumferences of front end portions of passages 311 each formed to extend in a longitudinal direction on an inner side of one of a plurality of conical protrusions 310 supported by a support surface 320.

Therefore, the washing water that has passed through the fine holes H may be sprayed in the form of a fine stream at the circumference of the front end portion of each of the passages 311.

When the fine holes H are radially formed along the circumferences of the front end portions of the passages 311 of the protrusions 310, the support surface 320 may include a helical groove 321 formed along a circumference of the passage 311, and in this way, as the washing water of the chamber part 200 swirls and flows over the helical groove 321, introduction of the washing water into the passage 311 may be facilitated.

Cleaning of a pore 11 using the pore cleansing and massage device A according to the present disclosure will be described in detail below.

Since the chamber part 200 of the present disclosure includes the inner space 210, washing water introduced from the outside can be accommodated by the inner space 210.

In addition, since the fine holes H are formed in the nozzle part 300 of the present disclosure, spraying, more specifically, direct spraying, of washing water in the form of fine streams can be performed due to the fine holes H.

However, there may be an inconvenience in a process of forming the fine holes H in the nozzle part 300.

However, according to one embodiment of the present disclosure, since, in the nozzle part 300, the fine holes H may be formed at the plurality of points on the disc member 330 insert-molded onto the support surface 320 supporting the plurality of protrusions 310 having the passages 311 extending in the longitudinal direction formed therein and may communicate with the passages 311, as the fine holes H are formed in the disc member 330, the formation of the fine holes H can be relatively simply performed, and an inconvenience caused by the formation of the fine holes H can be reduced.

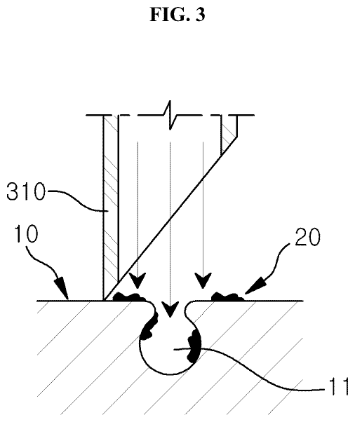

At this time, since the washing water that has passed through the fine holes His sprayed in the form of a fine stream through the passage 311 of each of the protrusions 310, as illustrated in FIG. 3, the surrounding protrusion 310 blocks contact between fine streams of washing water and hair, and the fine streams of washing water, in other words, fine droplets of washing water, can be easily delivered to the pore 11 of the skin 10 and around the pore 11, and thus contaminants 20 stuck in the pore 11 and around the pore 11 can be easily washed away.

Here, since the protrusion 310 of the nozzle part 300 includes the inclined surface 312 formed at a predetermined angle on one end located at a far distance from the support surface 320, due to the inclined surface 312, the passage 311 may be widely open at the front end of the protrusion 310, and as a result, vacuum formation inside the passage 311 can be prevented in a washing water spraying process, and the washing water can be more easily sprayed in the form of fine streams through the fine holes H.

However, there may be an inconvenience in an insert molding process of the disc member 330.

However, according to another embodiment of the present disclosure, since, in the nozzle part 300, the fine holes H may be formed at the plurality of points on the disc member 330 disposed in close contact with the inner side of the support surface 320 supporting the plurality of protrusions 310 having the passages 311 extending in the longitudinal direction formed therein and may communicate with the passages 311, spraying of washing water in the form of fine streams can be performed just by placing the disc member 330 on the inner side of the support surface 320 without insert-molding the disc member 330, and an inconvenience and a rate decrease caused by insert-molding of the disc member 330 can be reduced.

At this time, since the washing water that has passed through the fine holes H formed at the plurality of points on the disc member 330 disposed in close contact with the inner side of the support surface 320 is also sprayed in the form of a fine stream through the passage 311 of each of the protrusions 310, the surrounding protrusion 310 blocks contact between fine streams of washing water and hair, and the fine streams of washing water can be easily delivered to the pore 11 of the skin 10 and around the pore 11, and thus the contaminants 20 stuck in the pore 11 and around the pore 11 can be easily washed away.

Further, when the fine holes H are formed at the plurality of points on the disc member 330 disposed in close contact with the inner side of the support surface 320, since the protrusion 310 may further include the slit 313 formed to extend in the longitudinal direction from one end of the inclined surface 312 that is adjacent to the support surface 320, the protrusion 310 may also be open due to the slit 313, vacuum formation inside the passage 311 can be prevented in a washing water spraying process, and the washing water can be more easily sprayed in the form of fine streams through the fine holes H.

Also, according to another embodiment of the present disclosure, since, in the nozzle part 300, the fine holes H may be formed at the plurality of points on the support surface 320 supporting the plurality of protrusions 310 having the passages 311 extending in the longitudinal direction formed therein and may communicate with the passages 311, spraying of washing water in the form of fine streams can be performed without providing the disc member 330 itself, and thus manufacturing costs and production, assembly, and management costs can be reduced.

At this time, since the fine holes H may be further formed at the plurality of points on the support surface 320 outside the passage 311, spraying of washing water in the form of fine streams can also be performed through the fine holes H outside the passage 311, and thus it may be particularly easy to part hair and wash hair stuck between the protrusions 310.

Also, according to another embodiment of the present disclosure, in the nozzle part 300, the fine holes H may be formed at the plurality of points on the support surface 320 supporting the plurality of protrusions 310 and may face the protrusions 310, and the fine holes H may be radially formed at each of the plurality of points.

At this time, since the washing water that has passed through the fine holes H is sprayed in the form of a fine stream between any one and another of the plurality of wings 314 radially disposed on each protrusion 310, contact with hair is blocked by the plurality of wings 314, and the washing water affects the pore 11 and parts around the pore 11 while a sprayed form thereof is maintained intact, and thus the contaminants 20 stuck in the pore 11 and around the pore 11 can be easily washed away.

Here, since the wings 314 of the protrusion 310 may be formed with a width that gradually narrows toward a front end, and the front ends of the protrusions 310 including the wings 314 can become sharp, the front ends of the protrusions 310, more specifically, the front ends of the wings 314, may easily pass between hair strands, hair parting may be easily performed, and skin massage may be facilitated.

However, since the fine holes H radially formed at each of the plurality of points on the support surface 320 are spaced at a considerable distance from the skin 10 due to a length of the protrusion 310, delivery of washing water to the pore 11 and around the pore 11 may be hindered due to interference with hair.

However, according to another embodiment of the present disclosure, since, in the nozzle part 300, the fine holes H may be radially formed on the front ends of the passages 311 each formed to extend in the longitudinal direction on the inner side of one of the plurality of protrusions 310 supported by the support surface 320, the fine holes H can be closer to the skin 10, and fine streams of washing water can be more easily delivered to the pore 11 and around the pore 11, and thus the contaminants 20 in the pore 11 and around the pore 11 can be more easily washed away by the fine streams of washing water.

At this time, since the support surface 320 includes the helical groove 321 formed along the circumference of the passage 311, as the washing water of the chamber part 200 swirls and flows over the helical groove 321, introduction of the washing water into the passage 311 may be facilitated, and spraying of washing water in the form of fine streams can be further facilitated.

In addition, when the fine holes H are radially formed on the front ends of the passages 311 of the protrusions 310, since the central axes of the fine holes H may be parallel to the central axis of the protrusion 310 or may be misaligned with the central axis of the protrusion 310 and tilted 10 to 20° outward toward the front, in particular, as the central axes of the fine holes H are misaligned with the central axis of the protrusion 310 and tilted outward, the washing water sprayed in the form of a fine stream through each fine hole H may affect a larger area of a surface of the skin 10.

Also, when the fine holes H are radially formed on the front ends of the passages 311 of the protrusions 310, since the plurality of protrusions 310 may be separately manufactured using a flexible material such as rubber or silicone and may be fitted and coupled to the support surface 320, during massage of the skin 10 by the protrusions 310 coming into contact therewith, overstimulation can be suppressed due to characteristics of the material of the protrusions 310, and the massage may be facilitated.

Also, when the fine holes H are radially formed on the front ends of the passages 311 of the protrusions 310, since the protrusions 310 each include the moving member 315 passing through the center of arrangement of the wings 314 and coupled to be movable forward and rearward, as the forward and rearward movement of the moving member 315 occurs, stable contact with curved parts of the skin is possible, movement to the curved parts of the skin can be made easy by adjusting a frictional force when in contact with the skin, and thus hair can be parted easily by movement on the skin, washing water can be directly sprayed to pores while avoiding the hair, and massage can be easily performed even when the skin is curved.

Here, since the tip of the moving member 315 in the longitudinal direction that extends to the inner side of the passage 311 of the protrusion 310 is elastically supported by the elastic body 315a such as a coil spring, when pressure release occurs in an insertion state due to pressing, as the stretching force of the elastic body 315a acts, the moving member 315 may automatically return to a before-insertion state, that is, a protruding state, and thus an inconvenience in causing the moving member 315 in an inserted state to protrude may be reduced.

Also, since the moving member 315 may include the tip 315b that emits a microcurrent as power is applied thereto, as the tip 315b comes into contact with the skin 10 and emits the microcurrent, a massage effect can be further enhanced.

At this time, emission of the microcurrent through the tip 315b is only one example, and instead of the tip 315b, the moving member 315 itself may be formed as a conductor or a surface of the moving member 315 may be coated with a conductive material to emit a microcurrent.

Also, according to another embodiment of the present disclosure, since, in the nozzle part 300, the fine holes H may be radially formed along the circumferences of the front end portions of the passages 311 each formed to extend in the longitudinal direction on the inner side of one of the plurality of conical protrusions 310 supported by the support surface 320, the fine holes H can be closer to the skin 10 due to the passages 311, and fine streams of washing water can be more easily directly sprayed to the pore 11 and around the pore 11, and thus the contaminants 20 in the pore 11 and around the pore 11 can be more easily washed away by the fine streams of washing water.

At this time, since the support surface 320 includes the helical groove 321 formed along the circumference of the passage 311, as the washing water of the chamber part 200 swirls and flows over the helical groove 321, introduction of the washing water into the passage 311 can be facilitated, and thus spraying of washing water in the form of fine streams can be further facilitated.

The present disclosure is not limited to the embodiments described above, modifications may be made within the scope not departing from the gist of the present disclosure claimed in the claims, and such modifications belong to the protection scope of the present disclosure defined by the claims below.

1. A pore cleansing and massage device comprising:
a chamber part accommodating washing water introduced from the outside through an inner space thereof; and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are formed at a plurality of points on a disc member insert-molded onto a support surface supporting a plurality of protrusions having passages extending in a longitudinal direction formed therein and communicate with the passages, and the washing water that has passed through the fine holes is sprayed in the form of a fine stream through the passage of each of the protrusions, and
the protrusion of the nozzle part includes an inclined surface formed at a predetermined angle on one end located at a far distance from the support surface and further includes a slit formed to extend in a longitudinal direction from one end of the inclined surface that is adjacent to the support surface.

2. A pore cleansing and massage device comprising:
a chamber part accommodating washing water introduced from the outside through an inner space thereof; and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are formed at a plurality of points on a disc member disposed in close contact with an inner side of a support surface supporting a plurality of protrusions having passages extending in a longitudinal direction formed therein and communicate with the passages, and the washing water that has passed through the fine holes is sprayed in the form of a fine stream through the passage of each of the protrusions, and
the protrusion of the nozzle part includes an inclined surface inclined in one direction on a front end and further includes a slit formed to extend in a longitudinal direction from one end of the inclined surface that is adjacent to the support surface.

3. A pore cleansing and massage device comprising:
a chamber part accommodating washing water introduced from the outside through an inner space thereof; and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are formed at a plurality of points on a support surface supporting a plurality of protrusions having passages extending in a longitudinal direction formed therein and communicate with the passages, and the washing water that has passed through the fine holes is sprayed in the form of a fine stream through the passage of each of the protrusions, and
the protrusion of the nozzle part includes an inclined surface inclined in one direction on a front end and further includes a slit formed to extend in a longitudinal direction from one end of the inclined surface that is adjacent to the support surface.

4. The pore cleansing and massage device of claim 3, wherein the fine holes are further formed at the plurality of points on the support surface outside the passage.

5. A pore cleansing and massage device comprising:
a chamber part accommodating washing water introduced from the outside through an inner space thereof, and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are formed at a plurality of points on a support surface supporting a plurality of protrusions and face the protrusions, the fine holes are radially formed at each of the plurality of points, and the washing water that has passed through the fine holes is sprayed in the form of a fine stream between any one and another of a plurality of wings radially disposed on the protrusions.

6. The pore cleansing and massage device of claim 5, wherein the wings are formed with a width that gradually narrows toward a front end.

7. A pore cleansing and massage device comprising:
a chamber part accommodating washing water introduced from the outside through an inner space thereof; and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are radially formed on front ends of passages each formed to extend in a longitudinal direction on an inner side of one of a plurality of protrusions supported by a support surface, and the washing water that has passed through the fine holes is sprayed in the form of a fine stream between any one and another of a plurality of wings radially disposed on the protrusions.

8. The pore cleansing and massage device of claim 7, wherein the wings are formed with a width that gradually narrows toward a front end.

9. The pore cleansing and massage device of claim 7, wherein the support surface includes a helical groove formed along a circumference of the passage.

10. The pore cleansing and massage device of claim 7, wherein central axes of the fine holes formed radially on the front end of the passage are parallel to a central axis of the protrusion or misaligned with the central axis of the protrusion and tilted 10 to 20° outward toward the front.

11. The pore cleansing and massage device of claim 7, wherein the plurality of protrusions are separately manufactured using a flexible material and are fitted and coupled to the support surface.

12. The pore cleansing and massage device of claim 7, wherein the protrusions each include a moving member passing through a center of arrangement of the wings and coupled to be movable forward and rearward

13. The pore cleansing and massage device of claim 12, wherein a tip of the moving member in a longitudinal direction that extends to an inner side of the passage of the protrusion is elastically supported by an elastic body.

14. The pore cleansing and massage device of claim 12, wherein the moving member includes a conductor tip that emits a microcurrent as power is applied thereto.

15. A pore cleansing and massage device comprising:
a chamber part accommodating washing water introduced from the outside through an inner space thereof; and
a nozzle part coupled to the chamber part and spraying the washing water accommodated in the chamber part in the form of a plurality of fine streams through a plurality of fine holes communicating with the inner space of the chamber part,
wherein, in the nozzle part, the fine holes are radially formed along circumferences of front end portions of passages each formed to extend in a longitudinal direction on an inner side of one of a plurality of conical protrusions supported by a support surface, and the washing water that has passed through the fine holes is sprayed in the form of a fine stream at the circumference of the front end portion of each of the passages, and
the support surface includes a helical groove formed along a circumference of the passage.
